(19) United States
(12) Patent Application Publication
(10) Pub. No.: US 2021/0002527 A1
(43) Pub. Date: Jan. 7, 2021

(54) FIREPROOF GLUE SOLUTION MATRIX AND PREPARATION METHOD THEREOF AND FIREPROOF GLUE SOLUTION AND PREPARATION METHOD THEREOF

(71) Applicant: CHINA BUILDING MATERIALS ACADEMY CO., LTD, Beijing (CN)

(72) Inventors: Yuanchun MU, Beijing (CN); Dayan DU, Beijing (CN); Zhiwei XU, Beijing (CN); Yaohui LI, Beijing (CN); Lei XU, Beijing (CN); Jing FU, Beijing (CN); Jinzhen WANG, Beijing (CN); Fan ZHANG, Beijing (CN); Yuan AN, Beijing (CN)

(21) Appl. No.: 16/071,765

(22) PCT Filed: Mar. 8, 2017
(86) PCT No.: PCT/CN2017/075918

§ 371 Date: Jul. 20, 2018

(30) Foreign Application Priority Data
Feb. 21, 2017 (CN) 201710093142.0

(51) Int. Cl. C09J 151/10; C09J 11/04; C08F 292/00

(52) U.S. Cl. CPC C09J 151/10; C08K 3/36; C08F 292/00; C09J 11/04

(57) ABSTRACT

Provided is a fireproof glue solution matrix and a preparation method thereof and a fireproof glue solution and a preparation method thereof. The fireproof glue solution matrix comprises silicon dioxide and also comprises a lubricating substance, wherein the lubricating substance is a copolymer of aromatic olefin and/or acrylic ester. The fireproof glue solution comprises the fireproof glue solution matrix. The fireproof glue solution prepared by the present invention has a viscosity of only 50-1000 cp, and is suitable for preparing laminated fireproof glass with a fireproof layer of thickness of less than 1 mm. In addition, the fireproof layer made of the fireproof glue solution has advantages of good fireproof and heat-insulating properties, high in hardness, high transmittance and good ultraviolet resistance performance.

### TECHNICAL FIELD

The present invention relates to a fireproof glue solution and a preparation method thereof, and belongs to the field of fireproof safety glass.

### BACKGROUND

Fireproof glass is glass with fireproof function and used on building exterior wall or on doors and windows. Fireproof glass not only have the conventional functions of ordinary glass but also have special functions like controlling fire spreading, smoke separation and heat insulation and the like. At present, the fireproof glass is mainly divided into four classes: laminated fireproof glass, special fireproof glass, hollow fireproof glass and high-strength single-layer cesium-potassium fireproof glass, wherein laminated fireproof glass is classified as A-class fireproof glass, due to good light-transmitting performance, excellent fireproof Integrity (Integrity, E) and heat Insulation property (Insulation, I). The laminated fireproof glass can help to prevent escape personnel and rescue workers from being damaged by heat radiation in the fire, and can minimize the damage of the fire.

Structurally, the laminated fireproof glass is composed of two or more layers of glass, and transparent fireproof glue solution layer therebetween. When in the fire, the fireproof glue solution layer will foam and expand to form a heat-insulating fireproof foam layer, and heat generated by the fire can be absorbed. In addition, the fireproof glue solution layer can also be adhered to the broken glass sheet so as to keep the integrity of the whole glass.

At present, the fireproof glue solution for the specialized laminated fireproof glass is a mixture of water and sodium silicate, and a large amount of micro bubbles exist in the fireproof glue solution layer prepared by this fireproof glue solution, and the reason being: the viscosity of the fireproof glue solution formed after the mixing of water and the water glass is high, a large amount of micro-bubbles, which are hard to eliminate by defoaming agent, are easily formed in the process of filling the fireproof layer. However, the generation of the micro-bubbles not only affects the light transmittance and the appearance of the laminated fireproof glass, but also reduces the hardness and the fire resistance of the fireproof glue solution layer, thus the use effect and the service life of the fireproof glass is severely impacted.

To this end, Chinese patent application document CN105131761A discloses a fireproof solution for laminated fireproof glass, and the method for preparing this solution comprises: mixing and stirring polyhydric alcohols, a functional monomer, a heat-resistant stabilizer, a curing agent, a charring agent and deionized water to obtain a first mixed emulsion; and then mixing and stirring the first mixed emulsion with hydrophilic nano-silicon dioxide particles to obtain a nano-silicon dioxide particle dispersion emulsion; mixing and stirring styrene, methyl methacrylate and butyl acrylate to obtain a second mixed monomer emulsion; adding the second mixed monomer emulsion, a emulsifier, a cross-linking agent and deionized water to the nano-silicon dioxide particle dispersion emulsion, and heating to 60° C.-65° C., and then adding a redox initiator into the nano-silicon dioxide particle dispersion emulsion to form an inner shell layer around the nano-silicon dioxide particle, therefore a low-soap seed emulsion is obtained; mixing and stirring acrylic acid, styrene, methyl methacrylate and butyl acrylate to obtain a third mixed monomer emulsion; mixing the third mixed monomer emulsion, a emulsifier, deionized water, a redox initiator and a cross-linking agent into the low-soap seed emulsion, and reacting for 3-5 hours at a temperature of 60° C.-65° C., to form an outer shell layer around the inner shell layer, so that a two-layers core-shell structure is formed, and a low-soap core-shell emulsion is obtained; mixing the low-soap core-shell emulsion with an aqueous solution of potassium hydroxide and then adding a charring adjuvant, an ion fixing agent, a defoaming agent, a flatting agent and a curing agent, stirring, standing and filtering to obtain a filtrate which is the fireproof glue solution for laminated fireproof glass.

According to the aforementioned technique, the silicon dioxide particles are modified by forming a primary shell using the first mixed emulsion and the second mixed emulsion, and are further modified by forming a secondary shell using the third mixed emulsion. The formation of silicon hydroxyl is reduced in the process of preparing the fireproof glue solution with the third mixed emulsion and potassium hydroxide, so that the viscosity of the fireproof glue solution is partially reduced, the amount of the micro-bubbles formed in the process of filling the fireproof layer with the fireproof glue solution is reduced, the light transmittance and the thermal insulation performance of the fireproof glue solution are improved, and the hardness of the fireproof glue solution layer is increased.

Ultrathin laminated fireproof glass refers to laminated fireproof glass with a thickness of less than 1 mm. As the fireproof glue solution is filled into the spacing between the two sheets of glass with the help of height difference in the industrial process, therefore the thinner the fireproof glue solution layer is, the less viscosity the fireproof glue solution should be. However, the two-layer core-shell particles of the aforementioned fireproof glue solution structurally are positive core-shell particles which do not have thixotropy, thus the viscosity of the fireproof glue solution system is still high, and the requirements of ultrathin laminated fireproof glass cannot be met.

The aforementioned fireproof glue solution can only be used to prepare laminated fireproof glass with the fireproof layer having a thickness of more than 1 mm.

### SUMMARY OF THE INVENTION

The aim of the present invention is to overcome the problem that the ultra-thin laminated fireproof glass with the fireproof layer having a thickness of less than 1 mm cannot be prepared from the current fireproof glue solution as the viscosity is too high, and provide a fireproof glue solution and a preparation method thereof.

In one aspect, the present invention provides a fireproof glue solution matrix, comprising silicon dioxide, characterized by further comprising a lubricating substance, wherein the lubricating substance is a copolymer of aromatic olefin and/or acrylic ester.

Preferably the aromatic olefin is styrene and the acrylic ester is butyl acrylate.

Preferably the lubricating substance is particles.

Preferably the fireproof glue solution matrix comprises silicon dioxide as a core, an inner shell layer covering the silicon dioxide, and an outer shell layer covering the inner shell layer, wherein the lubricating substance is at least arranged between the inner shell layer and the silicon dioxide.

Preferably the lubricating substance is further arranged in the inner shell layer.

Preferably the inner shell layer is a polymer formed by one or more of acrylic acid, methacrylic acid and polyacrylamide; and the outer shell layer is a polymer formed by acrylic acid, styrene and butyl acrylate.

Preferably the silicon dioxide of the fireproof glue solution matrix is nano-scaled, with a particle size of 60-150 nm and a specific surface area of 60-120 m²/g.

Preferably the fireproof glue solution matrix is in a spherical shape.

In another aspect, the present invention provides a method for preparing the fireproof glue solution matrix, comprising the following steps:
(1) preparing an inner shell layer mixture solution by mixing glycerol, polymerization monomer and water, wherein the polymerization monomer is one or more of acrylic acid, methacrylic acid and polyacrylamide;
(2) preparing a soap-free seed emulsion by adding nano silicon dioxide particles and a redox initiator into the inner shell layer mixture solution under the protection of an inert gas;
(3) preparing a soap-free single-shell emulsion by adding a lubricating monomer, water and a redox initiator into the soap-free seed emulsion, wherein the lubricating monomer is aromatic olefin and/or acrylic ester; and
(4) preparing a fireproof glue solution matrix by adding a cross-linking monomer, water and a cross-linking agent into the soap-free single-shell emulsion and then adding a redox initiator, wherein the cross-linking monomer is acrylic acid, styrene and butyl acrylate.

Preferably the redox initiator is a mixture of ammonium persulfate and sodium hydrogen sulfite in a molar ratio of 1:1; and the cross-linking agent is 1,2-divinyl benzene in the method.

Preferably in step (3) of the method, the aromatic olefin is styrene, and the acrylic ester is butyl acrylate.

Preferably in step (1) of the method, the weight ratio of glycerol to the polymerization monomer to the water in the inner shell layer mixture solution is 15-20:2-25:35-50;

in step (2) of the method, the weight ratio of the inner shell layer mixture solution to the nano silicon dioxide particles to the redox initiator is 30-50:20-60:0.01-0.04;

in step (3) of the method, the weight ratio of the soap-free seed emulsion to the lubricating monomer to the redox initiator to the water is 50-100:1-5:0.01-0.05:1-10; and

in step (4) of the preparation method, the weight ratio of the soap-free single-shell emulsion to the cross-linking monomer to the cross-linking agent to the redox initiator to the water is 60-110:1-10:0.01-0.05:0.0125-0.05:1-10.

Preferably the polymerization monomer of the method is acrylic acid, methacrylic acid and polyacrylamide wherein the weight ratio of acrylic acid to methacrylic acid to polyacrylamide is: 2-10:0.01-10:0.01-5;

the lubricating monomer of the method is styrene and butyl acrylate, wherein the weight ratio of styrene to butyl acrylate is 30-45:30-40; and

the cross-linking monomer of the method is acrylic acid, styrene and butyl acrylate, wherein the weight ratio of acrylic acid to styrene to butyl acrylate is 15-20:50-70:10-15.

Preferably the step (1) of the method further comprises a step of adding a charring agent, a polyhydric alcohol, a heat stabilizer, a curing agent and potassium hydroxide.

Preferably the weight ratio of glycerol to the polymerization monomer to the charring agent to the polyhydric alcohol to the heat stabilizer to the curing agent to the potassium hydroxide to the water is 15-20:2-25:0.01-3:0.02-4:0.01-0.6:0.01-0.1:0.01-0.2:35-50;
wherein the charring agent is one or more of sucrose, fructose, glucose and granulated sugar;
the heat stabilizer is borax and/or boric acid;
the curing agent is one or more of sodium fluosilicate, potassium fluosilicate and aluminum fluoride; and
the polyhydric alcohol is xylitol and/or pentaerythritol.

Preferably the step (4) of the method further comprises a step of mixing the cross-linking monomer in advance; and a step of swelling after mixing the soap-free core-shell emulsion with the cross-linking monomer, water and the cross-linking agent.

In another aspect, the present invention provides a fireproof glue solution, comprising the fireproof glue solution matrix of the present invention.

Preferably the fireproof glue solution further comprises potassium hydroxide.

Preferably the weight ratio of the fireproof glue solution matrix to the potassium hydroxide is 70-75:2-15 in the fireproof glue solution.

Preferably the fireproof glue solution further comprises a charring adjuvant, an ion fixing agent, a defoaming agent and a curing agent.

Preferably the weight ratio of the fireproof glue solution matrix to the potassium hydroxide to the charring adjuvant to the ionic fixing agent to the defoaming agent to the curing agent is 70-75:2-15:0.01-0.2:0.01-0.1:0.01-0.05:0.01-0.2.

In another aspect, the present invention provides a method for preparing the fireproof glue solution, comprising the abovementioned steps for preparing the fireproof glue solution matrix, and further comprising the following step: mixing the fireproof glue solution matrix with potassium hydroxide to obtain the fireproof glue solution.

Preferably the method further comprising a step of adding a charring adjuvant, an ion fixing agent, a defoaming agent and a curing agent;
wherein the charring adjuvant is one or more of potassium dihydrogen phosphate, potassium hydrogen phosphate, sodium dihydrogen phosphate and sodium hydrogen phosphate;
the ion fixing agent is one or more of zinc oxide, aluminum oxide and starch;
the defoaming agent is polyether modified organic silicon or polyurethane type adjuvant; and
the curing agent is one or more of sodium fluosilicate, potassium fluosilicate and aluminum fluoride.

Preferably the method further comprises a step of stirring and defoaming under a vacuum degree of 10-40 mbar.

The technical solution of the present invention has the following advantages:

1. The fireproof glue solution matrix of the present invention is characterized in that the nano-silicon dioxide particles are modified with a lubricating substance formed by aromatic olefin and/or acrylic ester copolymer. The fireproof glue solution prepared by mixing the lubricating substance and the potassium hydroxide is relatively high in thixotropy as the lubricating substance is high in elasticity. The viscosity of the fireproof glue solution is greatly reduced.

2. The fireproof glue solution matrix of the present invention comprise silicon dioxide as the core which is covered with two shell layers. Lubricating substance formed by aromatic olefin and/or acrylic ester copolymer is arranged between the silicon dioxide and the inner shell layer. Since the lubricating substance has high-elasticity, relative deformation of the silicon dioxide particles and the inner shell layer is increased, and in addition the thixotropy of the entire fireproof glue matrix is increased. Therefore, the fireproof glue solution formed by the fireproof glue solution matrix and potassium hydroxide or sodium hydroxide has excellent thixotropy and is very low in viscosity.

3. In the disclosed method for preparing the fireproof glue solution matrix, a lubricating monomer is added after the forming of inner shell layer around the nano-silicon dioxide. Since the lubricating monomer has amphiphilic nature, the lubricating monomer forms droplets when it enters into the spacing between the nano-silicon dioxide and the inner shell layer, and thus during subsequent polymerization, a granular lubricating substance is formed. In this way, the lubricating substance is prevented from forming sheets covering around the nano-silicon dioxide, so that the formed fireproof glue solution matrix has high thixotropy.

4. The fireproof glue solution of the present invention is characterized in that the fireproof glue solution formed by mixing the fireproof glue solution matrix of the present invention with potassium hydroxide has a viscosity as low as 50-1000 cp, and is suitable for preparing laminated fireproof glass with the fireproof layer of thickness of less than 1 mm. In addition, the fireproof layer made of the fireproof glue solution has the advantages of good heat-insulating properties, high in hardness, high transmittance and good ultraviolet resistance performance.

### BRIEF DESCRIPTION OF THE DRAWINGS

To illustrate the embodiments of the present invention or the technical solution of the prior art more clearly, the drawings used in specific embodiments or the prior art are briefly described below. Apparently, the drawings in the following description are some embodiments of the present invention, and according to these drawings, an ordinary skilled person in the art can obtain other drawings without paying any creative effort.

FIG. 1 is a structural schematic diagram of the fireproof glue solution matrix prepared in embodiments 4 and 8 of the present invention;

FIG. 2 is an electron micrograph of the fireproof glue solution prepared in embodiments 4 and 8 of the present invention.

### DETAILED DESCRIPTION OF EMBODIMENTS

The technical scheme of the invention is clearly and completely described below., the embodiments of the invention are a part of the embodiments of the present invention., and not all embodiments are based on the embodiments of the present invention., and all other embodiments obtained by persons of ordinary skill in the art without creative efforts., which belongs to the protection scope of the invention. In addition, the invention is related to the different embodiments of the invention described below. The technical features can be mutually connected as long as no conflict exists between each other.

Preparation of redox initiator:

Ammonium persulfate and sodium hydrogen sulfite are mixed in a molar ratio of 1:1, and uniformly stirred to obtain a redox initiator

Embodiment 1

The embodiment provides a method for preparing a fireproof glue solution matrix, comprising the following steps:

(1) Mixing glycerol, a polymerization monomer and deionized water in a weight ratio of 15:2:50 respectively, stirring until uniform to obtain an inner shell layer mixture solution, wherein the polymerization monomer in this step comprises acrylic acid, methacrylic acid and polyacrylamide in a weight ratio of 2:0.01:0.01;

(2) Mixing the nano-silicon dioxide particles with the size of 60 nm with the inner shell layer mixture solution, carrying out ultrasonic dispersion, allowing standing for 24 hours, heating to 60° C., then adding a redox initiator at a rotating speed of 250 rpm under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 30:60:0.01;

(3) Mixing the soap-free seed emulsion, deionized water and a lubricating monomer, heating to 60° C., then adding a redox initiator at a rotating speed of 250 rpm under nitrogen protection, such that the lubricating monomer permeates and penetrates through the inner shell layer, and polymerizes for 30 minutes under the action of the redox initiator to form a lubricating substance, obtaining a soap-free single-shell emulsion, wherein the lubricating monomer in this step is prepared by mixing styrene and butyl acrylate in the weight ratio of 30:30, and the soap-free seed emulsion, the lubricating monomer, the redox initiator and the deionized water have a weight ratio of 50:1:0.01:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer in this step is prepared by mixing acrylic acid, styrene and butyl acrylate in the weight ratio of 15:50:10, and the soap-free single-shell emulsion, the cross-linked monomer, 1,2-divinyl benzene, the redox initiator and deionized water have the weight ratio of 60:1: 0.01:0.05:10.

Embodiment 2

The embodiment provides a method for preparing a fireproof glue solution matrix, comprising the following steps:

(1) Mixing glycerol, a polymerization monomer and deionized water in a weight ratio of 20:25:35 respectively, stirring until uniform to obtain an inner shell layer mixture solution, wherein the polymerization monomer in this step comprises acrylic acid, methacrylic acid and polyacrylamide in a weight ratio of 10:10:5;

(2) Mixing the nano-silicon dioxide particles with the size of 100 nm with the inner shell layer mixture solution, carrying out ultrasonic dispersion, allowing standing for 24 hours, heating to 65° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 50:20:0.04;

(3) Mixing the soap-free seed emulsion, deionized water and a lubricating monomer, heating to 60° C., then adding a redox initiator at a rotating speed of 250 rpm, under nitrogen protection, such that the lubricating monomer polymerizes for 30 minutes under the action of the redox initiator to form a lubricating substance, obtaining a soap-free single-shell emulsion, wherein the lubricating monomer in this step is prepared by mixing styrene and butyl acrylate in the weight ratio of 45:40, and the soap-free seed emulsion, the lubricating monomer, the redox initiator and the deionized water have a weight ratio of 100:1:0.05:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer in this step is prepared by mixing acrylic acid, styrene and butyl acrylate in the weight ratio of 20:70:15, and the soap-free single-shell emulsion, the cross-linked monomer, 1,2-divinyl benzene, the redox initiator and deionized water have the weight ratio of 110:10:0.01:0.0125:10.

Embodiment 3

The embodiment provides a method for preparing a fireproof glue solution matrix, comprising the following steps:

(1) Mixing glycerol, a polymerization monomer, sucrose, polyhydric alcohol, a heat stabilizer, sodium fluosilicate, potassium hydroxide and deionized water in a weight ratio of 15:25:2:2:0.3:0.05:0.1:40 respectively, stirring until uniform to obtain an inner shell layer mixture solution, wherein the polymerization monomer in this step comprises acrylic acid, methacrylic acid and polyacrylamide in a weight ratio of 10:0.01:5, the polyhydric alcohol comprises xylitol and pentaerythritol in a weight ratio of 1:1, and the heat stabilizer comprises borax and boric acid in a weight ratio of 1:1;

(2) Mixing the nano-silicon dioxide particles with the size of 60 nm with the inner shell layer mixture solution, carrying out ultrasonic dispersion, allowing standing for 24 hours, heating to 65° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 50:60:0.01;

(3) Mixing the soap-free seed emulsion, deionized water and a lubricating monomer, heating to 60° C., then adding a redox initiator at a rotating speed of 250 rpm, under nitrogen protection, such that the lubricating monomer permeates and penetrates through the inner shell layer, and polymerizes for 30 minutes under the action of the redox initiator to form a lubricating substance, obtaining a soap-free single-shell emulsion, wherein the lubricating monomer in this step is prepared by mixing styrene and butyl acrylate in the weight ratio of 30:40, and the soap-free seed emulsion, the lubricating monomer, the redox initiator and the deionized water have a weight ratio of 50:1:0.05:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer in this step is prepared by mixing acrylic acid, styrene and butyl acrylate in the weight ratio of 20:70:15, and the soap-free single-shell emulsion, the cross-linked monomer, 1,2-divinyl benzene, the redox initiator and deionized water have the weight ratio of 110:1:0.01:0.0125:1.

Embodiment 4

The embodiment provides a method for preparing a fireproof glue solution matrix, comprising the following steps:

(1) Mixing glycerol, a polymerization monomer and deionized water in a weight ratio of 15:6:30 respectively, stirring until uniform to obtain an inner shell layer mixture solution, wherein the polymerization monomer in this step comprises acrylic acid, methacrylic acid and polyacrylamide in a weight ratio of 1:1:1;

(2) Mixing the nano-silicon dioxide particles with the size of 60 nm with the inner shell layer mixture solution, carrying out ultrasonic dispersion, allowing standing for 24 hours, heating to 65° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 40:60:0.01;

(3) Mixing the soap-free seed emulsion, deionized water and a lubricating monomer, heating to 65° C., then adding a redox initiator at a rotating speed of 250 rpm, under nitrogen protection, such that the lubricating monomer permeates and penetrates through the inner shell layer, and polymerizes for 30 minutes under the action of the redox initiator to form a lubricating substance dispersed between the nano-silicon dioxide particles and the inner shell layer, obtaining a soap-free single-shell emulsion, wherein the lubricating monomer in this step is prepared by mixing styrene and butyl acrylate in the weight ratio of 35:30, and the soap-free seed emulsion, the lubricating monomer, the redox initiator and the deionized water have a weight ratio of 100:2:0.01:5;

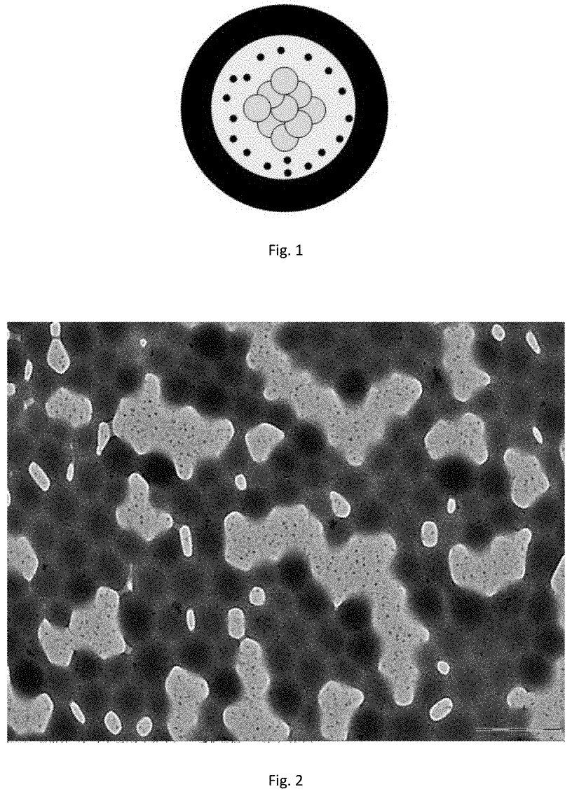

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix, i.e. an emulsion containing the fireproof glue solution matrix, wherein the structure of the fireproof glue solution matrix is shown in FIG. 1 and FIG. 2, and wherein FIG. 1 is a structural schematic diagram of the fireproof glue solution matrix and FIG. 2 is an electron micrograph of the fireproof glue solution matrix. The cross-linking monomer in this step is prepared by mixing acrylic acid, styrene and butyl acrylate in the weight ratio of 15:50:10, and the soap-free single-shell emulsion, the cross-linked monomer, 1,2-divinyl benzene, the redox initiator and deionized water have the weight ratio of 107:10:0.01:0.0125:10.

Embodiment 5

The embodiment provides a method for preparing a fireproof glue solution, comprising the following steps:

(1) Mixing glycerol, a polymerization monomer, fructose, xylitol, borax, sodium fluosilicate, potassium hydroxide and deionized water in a weight ratio of 15:2:0.01:0.02:0.01:0.1:0.2:50 respectively, stirring until uniform to obtain an inner shell layer mixture solution, wherein the polymerization monomer in this step comprises acrylic acid, methacrylic acid and polyacrylamide in a weight ratio of 2:0.01:0.01;

(2) Mixing the nano-silicon dioxide particles with the size of 150 nm with the inner shell layer mixture solution, carrying out ultrasonic dispersion, allowing standing for 24 hours, heating to 60° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 30:60:0.01;

(3) Mixing the soap-free seed emulsion, deionized water and a lubricating monomer, heating to 65° C., then adding a redox initiator at a rotating speed of 250 rpm, under nitrogen protection, such that the lubricating monomer permeates and penetrates through the inner shell layer, and polymerizes for 30 minutes under the action of the redox initiator to form a lubricating substance, obtaining a soap-free single-shell emulsion, wherein the lubricating monomer in this step is prepared by mixing styrene and butyl acrylate in the weight ratio of 30:30, and the soap-free seed emulsion, the lubricating monomer, the redox initiator and the deionized water have a weight ratio of 50:1:0.01:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer in this step is prepared by mixing acrylic acid, styrene and butyl acrylate in the weight ratio of 15:50:10, and the soap-free single-shell emulsion, the cross-linked monomer, 1,2-divinyl benzene, the redox initiator and deionized water have a weight ratio of 60:1:0.01:0.05:10;

(5) Mixing the fireproof glue solution matrix with potassium hydroxide, stirring for 20 minutes, and then sequentially adding potassium dihydrogen phosphate, zinc oxide, a polyamine additive and potassium fluosilicate, and stirring for 30 minutes under a vacuum degree of 25 mbar, removing bubbles in the liquid, and waiting until the liquid is cooled to room temperature at the vacuum degree of 25 mbar, then slowly raising the pressure to normal pressure. The liquid is filtered using a 100-mesh screen after standing for defoaming, to obtain a fireproof glue solution. In this step, the fireproof glue solution matrix, potassium hydroxide, potassium dihydrogen phosphate, zinc oxide, the polyurethane additive and potassium fluosilicate have a weight ratio of 70:2:0.2:0.1:0.05:0.01.

Embodiment 6

The embodiment provides a method for preparing a fireproof glue solution, comprising the following steps:

(1) Mixing glycerol, a polymerization monomer, fructose, xylitol, boric acid, sodium fluosilicate, potassium hydroxide and deionized water in a weight ratio of 20:25:3:4:0.6:0.01:0.01:35 respectively, stirring until uniform to obtain an inner shell layer mixture solution, wherein the polymerization monomer in this step comprises acrylic acid, methacrylic acid and polyacrylamide in a weight ratio of 10:10:5;

(2) Mixing the nano-silicon dioxide particles with the size of 80 nm with the inner shell layer mixture solution, carrying out ultrasonic dispersion, allowing standing for 24 hours, heating to 65° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have the weight ratio of 50:20:0.04;

(3) Mixing the soap-free seed emulsion, deionized water and a lubricating monomer, heating to 60° C., then adding a redox initiator at a rotating speed of 250 rpm, under nitrogen protection, such that the lubricating monomer polymerizes for 30 minutes under the action of the redox initiator to form a lubricating substance, obtaining a soap-free single-shell emulsion, wherein the lubricating monomer in this step is prepared by mixing styrene and butyl acrylate in the weight ratio of 45:40, and the soap-free seed emulsion, the lubricating monomer, the redox initiator and the deionized water have the weight ratio of 100:1:0.05:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer of this step is prepared by mixing acrylic acid, styrene and butyl acrylate in the weight ratio of 20:70:15, and the soap-free single-shell emulsion, the cross-linked monomer, 1,2-divinyl benzene, the redox initiator and deionized water have the weight ratio of 110:10:0.01:0.0125:10;

(5) Mixing the fireproof glue solution matrix with potassium hydroxide, stirring for 20 minutes, and then sequentially adding potassium dihydrogen phosphate, starch, polyether modified organic silicon and sodium fluosilicate, and stirring for 30 minutes under a vacuum degree of 10 mbar, removing bubbles in the liquid, and waiting until the liquid is cooled to room temperature at the vacuum degree of 10 mbar, then slowly raising the pressure to normal pressure. The liquid is filtered using a 100-mesh screen after standing for defoaming, to obtain a fireproof glue solution. In this step, the fireproof glue solution matrix, potassium hydroxide, potassium dihydrogen phosphate, starch, polyether modified organic silicon and sodium fluosilicate have a weight ratio of 70:10:0.1:0.05:0.02:0.02.

Embodiment 7

The embodiment provides a method for preparing a fireproof glue solution, comprising the following steps:

Mixing the fireproof glue solution matrix prepared in embodiment 3 with potassium hydroxide, stirring for 20 minutes, and then sequentially adding potassium dihydrogen phosphate, starch, polyether modified organic silicon and sodium fluosilicate, and stirring for 30 minutes under a vacuum degree of 40 mbar, removing bubbles in the liquid, and waiting until the liquid is cooled to room temperature at the vacuum degree of 40 mbar, then slowly raising the pressure to normal pressure. The liquid is filtered using a 100-mesh screen after standing for defoaming, to obtain a fireproof glue solution. The fireproof glue solution matrix, potassium hydroxide, potassium dihydrogen phosphate, starch, polyether modified organic silicon and sodium fluosilicate have a weight ratio of 75:10:0.01:0.035:0.01:0.15.

Embodiment 8

The embodiment provides a method for preparing a fireproof glue solution, comprising the following steps:

(1) Mixing glycerol, a polymerization monomer, sucrose, polyhydric alcohol, a heat stabilizer, sodium fluosilicate, potassium hydroxide and deionized water in a weight ratio of 15:6:1:2:0.6:0.05:0.15:30 respectively, stirring until uniform to obtain an inner shell layer mixture solution, wherein the polymerization monomer in this step comprises acrylic acid, methacrylic acid and polyacrylamide in a weight ratio of 1:1:1, the polyhydric alcohol comprises xylitol and pentaerythritol in a weight ratio of 1:1, and the heat stabilizer comprises borax and boric acid in a weight ratio of 1:1;

(2) Mixing the nano-silicon dioxide particles with the size of 60 nm with the inner shell layer mixture solution, carrying out ultrasonic dispersion, allowing standing for 24 hours, heating to 65° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 40:60:0.01;

(3) Mixing the soap-free seed emulsion, deionized water and a lubricating monomer, heating to 65° C., then adding a redox initiator at a rotating speed of 250 rpm, under nitrogen protection, such that the lubricating monomer permeates and penetrates through the inner shell layer, and polymerizes for 30 minutes under the action of the redox initiator to form a lubricating substance dispersed between the nano-silicon dioxide particles and the inner shell layer, obtaining a soap-free single-shell emulsion, wherein the lubricating monomer in this step is prepared by mixing styrene and butyl acrylate in the weight ratio of 35:30, and the soap-free seed emulsion, the lubricating monomer, the redox initiator and the deionized water have a weight ratio of 100:2:0.01:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix, i.e. an emulsion that contains the fireproof glue solution matrix. The structure of the fireproof glue solution matrix is shown in FIG. 1 and FIG. 2. FIG. 1 is a structural schematic diagram of the fireproof glue solution matrix particles and FIG. 2 is an electron micrograph of the fireproof glue solution matrix. The cross-linking monomer in this step is prepared by mixing acrylic acid, styrene and butyl acrylate in the weight ratio of 15:50:10, and the soap-free single-shell emulsion, the cross-linked monomer, 1,2-divinyl benzene, the redox initiator and deionized water have the weight ratio of 107:10:0.01:0.0125:10;

(5) Mixing the fireproof glue solution matrix with potassium hydroxide, stirring for 20 minutes and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. In this step, the fireproof glue solution matrix, potassium hydroxide, potassium dihydrogen phosphate, starch, polyether modified organic silicon and sodium fluosilicate have a weight ratio of 70:10:0.1:0.05:0.02:0.02.

Embodiment 9

The embodiment provides a method for preparing a fireproof glue solution, comprising the following steps:

(1) Mixing glycerol, a polymerization monomer, sucrose, polyhydric alcohol, a heat stabilizer, sodium fluosilicate, potassium hydroxide and deionized water in a weight ratio of 15:6:1:2:0.6:0.05:0.15:30 respectively, stirring until uniform to obtain an inner shell layer mixture solution, wherein the polymerization monomer in this step comprises acrylic acid, methacrylic acid and polyacrylamide in a weight ratio of 2:10:0.1, the polyhydric alcohol comprises xylitol and pentaerythritol in a weight ratio of 1:1, and the heat stabilizer comprises borax and boric acid in a weight ratio of 1:1;

(2) Mixing the nano-silicon dioxide particles with the size of 60 nm with the inner shell layer mixture solution, carrying out ultrasonic dispersion, allowing standing for 24 hours, heating to 65° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 40:50:0.03;

(3) Mixing the soap-free seed emulsion, deionized water and a lubricating monomer, heating to 65° C., then adding a redox initiator at a rotating speed of 250 rpm, under nitrogen protection, such that the lubricating monomer permeates and penetrates through the inner shell layer, and polymerizes for 30 minutes under the action of the redox initiator to form a lubricating substance, obtaining a soap-free single-shell emulsion, wherein the lubricating monomer in this step is prepared by mixing styrene and butyl acrylate in the weight ratio of 30:40, and the soap-free seed emulsion, the lubricating monomer, the redox initiator and the deionized water have a weight ratio of 80:5:0.03:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer in this step is prepared by mixing acrylic acid, styrene and butyl acrylate in the weight ratio of 20:50:10, and the soap-free single-shell emulsion, the cross-linked monomer, 1,2-divinyl benzene, the redox initiator and deionized water have a weight ratio of 107:10:0.01:0.0125:10;

(5) Mixing the fireproof glue solution matrix with potassium hydroxide, stirring for 20 minutes, and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. In this step, the fireproof glue solution matrix, potassium hydroxide, potassium dihydrogen phosphate, starch, polyether modified organic silicon and sodium fluosilicate have a weight ratio of 72:6:0.1:0.1:0.03:0.08.

Embodiment 10

The embodiment provides a method for preparing a fireproof glue solution, comprising the following steps:

(1) Mixing glycerol, a polymerization monomer, sucrose, polyhydric alcohol, a heat stabilizer, sodium fluosilicate, potassium hydroxide and deionized water in a weight ratio of 15:6:1:2:0.6:0.05:0.15:30 respectively, stirring until uniform to obtain an inner shell layer mixture solution, wherein the polymerization monomer in this step comprises acrylic acid, methacrylic acid and polyacrylamide in a weight ratio of 2:10:5, the polyhydric alcohol comprises xylitol and pentaerythritol in a weight ratio of 1:1, and the heat stabilizer comprises borax and boric acid in a weight ratio of 1:1;

(2) Mixing the nano-silicon dioxide particles with the size of 60 nm with the inner shell layer mixture solution, carrying out ultrasonic dispersion, allowing standing for 24 hours, heating to 60° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 50:50:0.02;

(3) Mixing the soap-free seed emulsion, deionized water and a lubricating monomer, heating to 65° C., then adding a redox initiator at a rotating speed of 250 rpm, under nitrogen protection, such that the lubricating monomer permeates and penetrates through the inner shell layer, and polymerizes for 30 minutes under the action of the redox initiator to form a lubricating substance, obtaining a soap-free single-shell emulsion, wherein the lubricating monomer in this step is prepared by mixing styrene and butyl acrylate in the weight ratio of 30:40, and the soap-free seed emulsion, the lubricating monomer, the redox initiator and the deionized water have a weight ratio of 60:4:0.04:2;

(4) Mixing the soap-free single-shell emulsion, deionized water, a cross-linking monomer and 1, 2-divinyl benzene, stirring for 5 hours, and standing and swelling for more than 24 hours, heating to 60° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer of this step is prepared by mixing acrylic acid, styrene and butyl acrylate in the weight ratio of 20:50:10, and the soap-free single-shell emulsion, the cross-linked monomer, 1,2-divinyl benzene, the redox initiator and deionized water have a weight ratio of 70:5:0.03:0.03:5;

(5) Mixing the fireproof glue solution matrix with potassium hydroxide, stirring for 20 minutes and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. In this step, the fireproof glue solution matrix, potassium hydroxide, potassium dihydrogen phosphate, starch, polyether modified organic silicon and sodium fluosilicate have a weight ratio of 73:9:0.05:0.05:0.02:0.15.

Embodiment 11

The embodiment provides a method for preparing a fireproof glue solution, comprising the following steps:

(1) Mixing glycerol, acrylic acid, sucrose, polyhydric alcohol, a heat stabilizer, sodium fluosilicate, potassium hydroxide and deionized water in a weight ratio of 15:6:1:2:0.6:0.05:0.15:30 respectively, stirring until uniform to obtain an inner shell layer mixture solution, wherein in this step, the polyhydric alcohol comprises xylitol and pentaerythritol in a weight ratio of 1:1, and the heat stabilizer comprises borax and boric acid in a weight ratio of 1:1;

(2) Mixing the nano-silicon dioxide particles with the size of 60 nm with the inner shell layer mixture solution, carrying out ultrasonic dispersion, allowing standing for 24 hours, heating to 65° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 40:60:0.01;

(3) Mixing the soap-free seed emulsion, deionized water and a lubricating monomer, heating to 65° C., then adding a redox initiator at a rotating speed of 250 rpm, under nitrogen protection, such that the lubricating monomer permeates and penetrates through the inner shell layer, and polymerizes for 30 minutes under the action of the redox initiator to form a lubricating substance dispersed between the nano-silicon dioxide particles and the inner shell layer, obtaining a soap-free single-shell emulsion, wherein the lubricating monomer in this step is prepared by mixing styrene and butyl acrylate in the weight ratio of 35:30, and the soap-free seed emulsion, the lubricating monomer, the redox initiator and the deionized water have a weight ratio of 70:2:0.01:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer in this step is prepared by mixing acrylic acid, styrene and butyl acrylate in the weight ratio of 15:50:10, and the soap-free single-shell emulsion, the cross-linked monomer, 1,2-divinyl benzene, the redox initiator and deionized water have a weight ratio of 80:10:0.01:0.0125:10;

(5) Mixing the fireproof glue solution matrix with potassium hydroxide, stirring for 20 minutes and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. In this step, the fireproof glue solution matrix, potassium hydroxide, potassium dihydrogen phosphate, starch, polyether modified organic silicon and sodium fluosilicate have a weight ratio of 70:10:0.1:0.05:0.02:0.02.

Embodiment 12

The embodiment provides a method for preparing a fireproof glue solution, comprising the following steps:

(1) Mixing glycerol, methacrylic acid, sucrose, polyhydric alcohol, a heat stabilizer, sodium fluosilicate, potassium hydroxide and deionized water in a weight ratio of 15:6:1:2:0.6:0.05:0.15:30 respectively, stirring until uniform to obtain an inner shell layer mixture solution, wherein in this step the polyhydric alcohol comprises xylitol and pentaerythritol in a weight ratio of 1:1, and the heat stabilizer comprises borax and boric acid in a weight ratio of 1:1;

(2) Mixing the nano-silicon dioxide particles with the size of 60 nm with the inner shell layer mixture solution, carrying out ultrasonic dispersion, allowing standing for 24 hours, heating to 65° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 35:45:0.04;

(3) Mixing the soap-free seed emulsion, deionized water and a lubricating monomer, heating to 65° C., then adding a redox initiator at a rotating speed of 250 rpm, under nitrogen protection, such that the lubricating monomer permeates and penetrates through the inner shell layer, and polymerizes for 30 minutes under the action of the redox initiator to form a lubricating substance dispersed between the nano-silicon dioxide particles and the inner shell layer, obtaining a soap-free single-shell emulsion, wherein the lubricating monomer in this step is prepared by mixing styrene and butyl acrylate in the weight ratio of 35:30, and the soap-free seed emulsion, the lubricating monomer, the redox initiator and the deionized water have a weight ratio of 75:2:0.01:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer of this step is prepared by mixing acrylic acid, styrene and butyl acrylate in the weight ratio of 15:50:10, and the soap-free single-shell emulsion, the cross-linked monomer, 1,2-divinyl benzene, the redox initiator and deionized water have a weight ratio of 100:10:0.01:0.0125:10;

(5) Mixing the fireproof glue solution matrix with potassium hydroxide, stirring for 20 minutes and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. In this step, the fireproof glue solution matrix, potassium hydroxide, potassium dihydrogen phosphate, starch, polyether modified organic silicon and sodium fluosilicate have a weight ratio of 70:10:0.1:0.05:0.02:0.02.

Embodiment 13

The embodiment provides a method for preparing a fireproof glue solution, comprising the following steps:

(1) Mixing glycerol, polyacrylamide, sucrose, polyhydric alcohol, a heat stabilizer, sodium fluosilicate, potassium hydroxide and deionized water in a weight ratio of 15:6:1:2:0.6:0.05:0.15:30 respectively, stirring until uniform to obtain an inner shell layer mixture solution, wherein in this step the polyhydric alcohol comprises xylitol and pentaerythritol in a weight ratio of 1:1, and the heat stabilizer comprises borax and boric acid in a weight ratio of 1:1;

(2) Mixing the nano-silicon dioxide particles with the size of 60 nm with the inner shell layer mixture solution, carrying out ultrasonic dispersion, allowing standing for 24 hours, heating to 65° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 45:25:0.02;

(3) Mixing the soap-free seed emulsion, deionized water and a lubricating monomer, heating to 65° C., then adding a redox initiator at a rotating speed of 250 rpm, under nitrogen protection, such that the lubricating monomer permeates and penetrates through the inner shell layer, and polymerizes for 30 minutes under the action of the redox initiator to form a lubricating substance which is dispersed between the nano-silicon dioxide particles and the inner shell layer, obtaining a soap-free single-shell emulsion, wherein the lubricating monomer in this step is prepared by mixing styrene and butyl acrylate in the weight ratio of 35:30, and the soap-free seed emulsion, the lubricating monomer, the redox initiator and the deionized water have a weight ratio of 90:2:0.01:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer of this step is prepared by mixing acrylic acid, styrene and butyl acrylate in the weight ratio of 15:50:10, and the soap-free single-shell emulsion, the cross-linked monomer, 1,2-divinyl benzene, the redox initiator and deionized water have a weight ratio of 100:10:0.01:0.0125:10;

(5) Mixing the fireproof glue solution matrix with potassium hydroxide, stirring for 20 minutes and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. In this step, the fireproof glue solution matrix, potassium hydroxide, potassium dihydrogen phosphate, starch, polyether modified organic silicon and sodium fluosilicate have a weight ratio of 70:10:0.1:0.05:0.02:0.02.

Embodiment 14

The embodiment provides a method for preparing a fireproof glue solution, comprising the following steps:

(1) Mixing glycerol, a polymerization monomer, sucrose, polyhydric alcohol, a heat stabilizer, sodium fluosilicate, potassium hydroxide and deionized water in a weight ratio of 15:6:1:2:0.6:0.05:0.15:30 respectively, stirring until uniform to obtain an inner shell layer mixture solution, wherein the polymerization monomer in this step comprises acrylic acid and methacrylic acid in a weight ratio of 1:1, the polyhydric alcohol comprises xylitol and pentaerythritol in a weight ratio of 1:1, and the heat stabilizer comprises borax and boric acid in a weight ratio of 1:1;

(2) Mixing the nano-silicon dioxide particles with the size of 60 nm with the inner shell layer mixture solution, carrying out ultrasonic dispersion, allowing standing for 24 hours, heating to 65° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 40:60:0.01;

(3) Mixing the soap-free seed emulsion, deionized water and a lubricating monomer, heating to 65° C., then adding a redox initiator at a rotating speed of 250 rpm, under nitrogen protection, such that the lubricating monomer permeates and penetrates through the inner shell layer, and polymerizes for 30 minutes under the action of the redox initiator to form a lubricating substance which is dispersed between the nano-silicon dioxide particles and the inner shell layer, obtaining a soap-free single-shell emulsion, wherein the lubricating monomer in this step is prepared by mixing styrene and butyl acrylate in the weight ratio of 35:30, and the soap-free seed emulsion, the lubricating monomer, the redox initiator and the deionized water have a weight ratio of 95:2:0.01:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer in this step is prepared by mixing acrylic acid, styrene and butyl acrylate in the weight ratio of 15:50:10, and the soap-free single-shell emulsion, the cross-linked monomer, 1,2-divinyl benzene, the redox initiator and deionized water have a weight ratio of 110:10:0.01:0.0125:10;

(5) Mixing the fireproof glue solution matrix with potassium hydroxide, stirring for 20 minutes and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. In this step, the fireproof glue solution matrix, potassium hydroxide, potassium dihydrogen phosphate, starch, polyether modified organic silicon and sodium fluosilicate have a weight ratio of 70:10:0.1:0.05:0.02:0.02.

Embodiment 15

The embodiment provides a method for preparing a fireproof glue solution, comprising the following steps:

(1) Mixing glycerol, a polymerization monomer, sucrose, polyhydric alcohol, a heat stabilizer, sodium fluosilicate, potassium hydroxide and deionized water in a weight ratio of 15:6:1:2:0.6:0.05:0.15:30 respectively, stirring until uniform to obtain an inner shell layer mixture solution, wherein the polymerization monomer in this step comprises acrylic acid and polyacrylamide in a weight ratio of 1:1, the polyhydric alcohol comprises xylitol and pentaerythritol in a weight ratio of 1:1, and the heat stabilizer comprises borax and boric acid in a weight ratio of 1:1;

(2) Mixing the nano-silicon dioxide particles with the size of 60 nm with the inner shell layer mixture solution, carrying out ultrasonic dispersion, allowing standing for 24 hours, heating to 65° C., then adding a redox initiator at a rotating speed of 250 rpm, under nitrogen protection, allowing polymerizing for 30 minutes, so that the polymerization monomer is subjected to a polymerization reaction under the action of the redox initiator to form an inner shell layer outside the nano-silicon dioxide particles, obtaining a soap-free seed emulsion, wherein in this step the inner shell layer mixture solution, the nano-silicon dioxide particles and the redox initiator have a weight ratio of 50:60:0.01;

(3) Mixing the soap-free seed emulsion, deionized water and a lubricating monomer, heating to 65° C., then adding a redox initiator at a rotating speed of 250 rpm, under nitrogen protection, such that the lubricating monomer permeates and penetrates through the inner shell layer, and polymerizes for 30 minutes under the action of the redox initiator to form a lubricating substance which is dispersed between the nano-silicon dioxide particles and the inner shell layer, obtaining a soap-free single-shell emulsion, wherein the lubricating monomer in this step is prepared by mixing styrene and butyl acrylate in the weight ratio of 35:30, and the soap-free seed emulsion, the lubricating monomer, the redox initiator and the deionized water have a weight ratio of 100:2:0.02:3;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to form an outer shell layer surrounding the inner shell layer, obtaining a fireproof glue solution matrix. The cross-linking monomer in this step is prepared by mixing acrylic acid, styrene and butyl acrylate in the weight ratio of 15:50:10, and the soap-free single-shell emulsion, the cross-linked monomer, 1,2-divinyl benzene, the redox initiator and deionized water have a weight ratio of 95:8:0.04:0.04:4;

(5) Mixing the fireproof glue solution matrix with potassium hydroxide, stirring for 20 minutes and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. In this step, the fireproof glue solution matrix, potassium hydroxide, potassium dihydrogen phosphate, starch, polyether modified organic silicon and sodium fluosilicate have a weight ratio of 75:15:0.15:0.1:0.04:0.2.

Embodiment 16

The embodiment provides a method for preparing a fireproof glue solution, comprising the following steps:

Mixing the fireproof glue solution matrix prepared in embodiment 1 with potassium hydroxide, stirring for 20 minutes and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. The fireproof glue solution matrix, potassium hydroxide, potassium dihydrogen phosphate, starch, polyether modified organic silicon and sodium fluosilicate have a weight ratio of 70:10:0.1:0.05:0.02:0.02.

Embodiment 17

The embodiment provides a method for preparing a fireproof glue solution, comprising the following steps:

Mixing the fireproof glue solution matrix prepared in embodiment 2 with potassium hydroxide, stirring for 20 minutes and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. The fireproof glue solution matrix, potassium hydroxide, potassium dihydrogen phosphate, starch, polyether modified organic silicon and sodium fluosilicate have a weight ratio of 70:10:0.1:0.05:0.02:0.02.

Embodiment 18

The embodiment provides a method for preparing a fireproof glue solution, comprising the following steps:

Mixing the fireproof glue solution matrix prepared in embodiment 4 with potassium hydroxide, stirring for 20 minutes and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. The fireproof glue solution matrix, potassium hydroxide, potassium dihydrogen phosphate, starch, polyether modified organic silicon and sodium fluosilicate have a weight ratio of 70:10:0.1:0.05:0.02:0.02.

### COMPARATIVE EXAMPLE

The embodiment provides a method for preparing a fireproof glue solution, comprising the following steps:

(1) Mixing glycerol, a polymerization monomer, sucrose, polyhydric alcohol, a heat stabilizer, sodium fluosilicate, potassium hydroxide and deionized water in a weight ratio of 15:6:1:2:0.6:0.05:0.15:30 respectively, stirring to uniform, wherein the polymerization monomer in this step comprises acrylic acid, methacrylic acid and polyacrylamide in a weight ratio of 1:1:1, the polyhydric alcohol comprises xylitol and pentaerythritol in a weight ratio of 1:1, and the heat stabilizer comprises borax and boric acid in a weight ratio of 1:1;

(2) Mixing the nano-silicon dioxide particles with the size of 60 nm with the inner shell layer mixture solution, carrying out ultrasonic dispersion, allowing standing for 24 hours to obtain a soap-free seed emulsion, wherein in this step the inner shell layer mixture solution and the nano-silicon dioxide particles have a weight ratio of 40:60;

(3) Mixing the soap-free seed emulsion, deionized water and a lubricating monomer, heating to 65° C., then adding a redox initiator at a rotating speed of 250 rpm, under nitrogen protection, such that the lubricating monomer polymerizes for 30 minutes under the action of the redox initiator to obtain a soap-free single-shell emulsion, wherein the lubricating monomer in this step is prepared by mixing styrene and butyl acrylate in the weight ratio of 35:30, and the soap-free seed emulsion, the lubricating monomer, the redox initiator and the deionized water have a weight ratio of 100:2:0.01:5;

(4) Mixing the soap-free single-shell emulsion, deionized water, a cross-linking monomer and 1, 2-divinyl benzene, stirring for 5 hours, and standing and swelling for more than 24 hours, heating to 65° C., adding a redox initiator under the protection of nitrogen, and further carrying out heat preservation and curing for 2 hours, such that the cross-linking monomer is cross-linked under the action of the cross-linking agent and the redox initiator to forming an outer shell layer surrounding the inner shell layer, obtaining a fireproof glue solution matrix. The cross-linking monomer in this step is prepared by mixing acrylic acid, styrene and butyl acrylate in the weight ratio of 15:50:10, and the soap-free single-shell emulsion, the cross-linked monomer, 1,2-divinyl benzene, the redox initiator and deionized water have a weight ratio of 107:10:0.01:0.0125:10;

(5) Mixing the fireproof glue solution matrix with potassium hydroxide, stirring for 20 minutes and then sequentially adding potassium dihydrogen phosphate, starch, polyether modified organic silicon and sodium fluosilicate, and stirring for 30 minutes under a vacuum degree of 20 mbar, removing bubbles in the liquid, and waiting until the liquid is cooled to room temperature at the vacuum degree of 20 mbar, then slowly raising the pressure to normal pressure. The liquid is filtered using a 100-mesh screen after standing for defoaming, to obtain a fireproof glue solution. In this step, the fireproof glue solution matrix, potassium hydroxide, potassium dihydrogen phosphate, starch, polyether modified organic silicon and sodium fluosilicate have a weight ratio of 70:10:0.1:0.05:0.02:0.02.

Test Example

1. Viscosity The fireproof glue solutions prepared in embodiments 5-18 and in comparative example are tested for viscosity with the help of a viscosity meter, and the result is shown in table 1.

TABLE 1

| | Viscosity |
|---|---|
| | (cp) |
| Embodiment 5 | 364.2 |
| Embodiment 6 | 394.6 |
| Embodiment 7 | 333.2 |
| Embodiment 8 | 243.4 |
| Embodiment 9 | 287.9 |
| Embodiment 10 | 299.7 |
| Embodiment 11 | 457.8 |
| Embodiment 12 | 490.1 |
| Embodiment 13 | 520.9 |
| Embodiment 14 | 545.3 |
| Embodiment 15 | 470.8 |
| Embodiment 16 | 374.2 |
| Embodiment 17 | 384.6 |
| Embodiment 18 | 265.4 |
| Comparative | 2400.5 |
| example | |

Form table 1, the viscosity of fireproof glue solutions prepared in the embodiments 5-18 is significantly lower than that of fireproof glue solution prepared in the comparative example.

2. Fireproof Performance, Ultraviolet-Resistant Irradiation Time and Transmittance Detection

Preparation of test glass
a, selecting 5 sheets of curved surface special-shaped glasses, each with a thickness of 4 mm, and the surface shape of each glass is consistent;
b, coating any one of the 5 glass sheets with a single-layer of silicon dioxide (SiO2) as an anti-reflection layer with a thickness of 0.1 mm on the convex surface thereof;
c, laminating the 5 glass sheets one by one with a weather-resistant surrounding sealing strip which has a thickness of 0.75 mm and a width smaller than 5 mm, leading to formation of four closed cavities with each having a thickness of 0.75 mm and having an opening for filling that is formed in the upper portion and has a width of 10 mm, wherein the glass with the anti-reflection layer is placed as the outermost layer;
d, filling each cavity with the fireproof glue solution prepared in embodiment 5, standing, defoaming and sealing;
e, placing the filled glass in a still kettle, and raising the pressure to 0.5 Mpa and temperature to about 80° C. simultaneously, and steaming for 120 minutes, taking the glass out after cooling to room temperature to obtain a laminated fireproof glass with five glass layers and four fireproof layers, named as laminated fireproof glass No. 1, wherein the thickness of each fireproof layer is 0.75 mm;
f, according to the aforementioned method, preparing laminated fireproof glasses filled with the fireproof glue solutions prepared in embodiments 5-18, and the resulted laminated fireproof glasses are numbered as No. 2-14 respectively.

The laminated fireproof glasses No. 1-14 are tested to determine the fireproof performance, the ultraviolet-resistant time and the transmittance, and the results are shown in table 2.

Fireproof performance of the laminated fireproof glasses No. 1-14 is tested according to the Chinese national standard GB/T12513-2006, and the result is shown in table 2;

Ultraviolet-resistant time of the laminated fireproof glasses No. 1-14 is tested according to the Chinese national standard GB 15763.1-2009, Safe Glass For Building, Part 1: Fireproof Glass, and the result is shown in table 2;

Transmittance of the laminated fireproof glasses No. 1-14 is tested according to the Chinese national standard GB 15763.1-2009, Safe Glass For Building, Part 1: Fireproof Glass, and the result is shown in table 2;

Appearance quality of the laminated fireproof glasses No. 1-14 is evaluated by naked eyes, and the result is shown in table 2.

TABLE 2

| | | Ultraviolet- | Fire- | |
|---|---|---|---|---|
| | | resistant | proof | |
| | Trans- | time/ | time/ | |
| No. | mittance | h | h | Appearance |
| 1 | 80% | 1500 | 70 | No microbubble, no corrosion |
| | | | | found on anti-reflection layer |
| 2 | 83% | 1700 | 70 | No microbubble, no corrosion |
| | | | | found on anti-reflection layer |
| 3 | 85% | 1650 | 70 | No microbubble, no corrosion |
| | | | | found on anti-reflection layer |
| 4 | 87% | 2000 | 75 | No microbubble, no corrosion |
| | | | | found on anti-reflection layer |
| 5 | 84% | 1800 | 70 | No microbubble, no corrosion |
| | | | | found on anti-reflection layer |
| 6 | 83% | 1900 | 70 | No microbubble, no corrosion |
| | | | | found on anti-reflection layer |
| 7 | 83% | 1550 | 65 | No microbubble, no corrosion |
| | | | | found on anti-reflection layer |
| 8 | 82% | 1850 | 65 | No microbubble, no corrosion |
| | | | | found on anti-reflection layer |
| 9 | 81% | 1750 | 60 | No microbubble, no corrosion |
| | | | | found on anti-reflection layer |
| 10 | 80% | 1750 | 60 | No microbubble, no corrosion |
| | | | | found on anti-reflection layer |
| 11 | 80% | 1850 | 65 | No microbubble, no corrosion |
| | | | | found on anti-reflection layer |
| 12 | 81% | 1550 | 70 | No microbubble, no corrosion |
| | | | | found on anti-reflection layer |
| 13 | 81% | 1700 | 70 | No microbubble, no corrosion |
| | | | | found on anti-reflection layer |
| 14 | 85% | 1950 | 70 | No microbubble, no corrosion |
| | | | | found on anti-reflection layer |

Form table 2, the fireproof time is longer than 60 hours and the transmittance is more than 80% for all the laminated fireproof glasses No. 1-14.

The ultraviolet-resistant time of all the laminated fireproof glasses No. 1-14 is longer than 100 hours as required by the Chinese national standard GB 15763.1-2009, Safe Glass For Building, Part 1: Fireproof Glass.

Apparently, the aforementioned embodiments are merely examples illustrated for clearly describing the present invention, rather than limiting the implementation ways thereof. For those skilled in the art, various changes and modifications in other different forms can be made on the basis of the aforementioned description. It is unnecessary and impossible to exhaustively list all the implementation ways herein. However, any obvious changes or modifications derived from the aforementioned description are intended to be embraced within the protection scope of the present invention.

1-24. (canceled)

25. A fireproof glue solution matrix, comprising silicon dioxide and a lubricating substance, wherein the lubricating substance is at least one of a copolymer of aromatic olefin and acrylic ester.

26. The fireproof glue solution matrix according to claim 25, wherein
the aromatic olefin is styrene; and
the acrylic ester is butyl acrylate.

27. The fireproof glue solution matrix according to claim 25, wherein the lubricating substance is particles.

28. The fireproof glue solution matrix according to claim 25, wherein the fireproof glue solution matrix comprises
silicon dioxide as a core,
an inner shell layer covering the silicon dioxide, and
an outer shell layer covering the inner shell layer,
wherein the lubricating substance is at least arranged between the inner shell layer and the silicon dioxide.

29. The fireproof glue solution matrix according to claim 28, wherein the lubricating substance is further arranged in the inner shell layer.

30. The fireproof glue solution matrix according to claim 28, wherein
the inner shell layer is a polymer formed by one or more of acrylic acid, methacrylic acid and polyacrylamide; and
the outer shell layer is a polymer formed by acrylic acid, styrene and butyl acrylate.

31. The fireproof glue solution matrix according to claim 25, wherein the silicon dioxide is nano-scaled, with a particle size of 60-150 nm and a specific surface area of 60-120 m²/g.

32. The fireproof glue solution matrix according to claim 25, wherein the fireproof glue solution matrix is in a spherical shape.

33. A method for preparing the fireproof glue solution matrix according to claim 25, comprising the following steps:
(1) preparing an inner shell layer mixture solution by mixing glycerol, polymerization monomer and water, wherein the polymerization monomer is one or more of acrylic acid, methacrylic acid and polyacrylamide;
(2) preparing a soap-free seed emulsion by adding nano silicon dioxide particles and a redox initiator into the inner shell layer mixture solution under the protection of an inert gas, wherein the redox initiator is a mixture of ammonium persulfate and sodium hydrogen sulfite in a molar ratio of 1:1;
(3) preparing a soap-free single-shell emulsion by adding a lubricating monomer, water and a redox initiator into the soap-free seed emulsion, wherein the lubricating monomer is aromatic olefin and/or acrylic ester, wherein the aromatic olefin is styrene, and the acrylic ester is butyl acrylate; and
(4) preparing a fireproof glue solution matrix by adding a cross-linking monomer, water and a cross-linking agent into the soap-free single-shell emulsion and then adding a redox initiator, wherein the cross-linking monomer is acrylic acid, styrene and butyl acrylate, wherein the cross-linking agent is 1,2-divinyl benzene.

34. The preparation method according to claim 33, wherein:
in step (1), a weight ratio of glycerol to the polymerization monomer to the water in the inner shell layer mixture solution is 15-20:2-25:35-50;
in step (2), a weight ratio of the inner shell layer mixture solution to the nano silicon dioxide particles to the redox initiator is 30-50:20-60:0.01-0.04;
in step (3), a weight ratio of the soap-free seed emulsion to the lubricating monomer to the redox initiator to the water is 50-100:1-5:0.01-0.05:1-10;
in step (4), a weight ratio of the soap-free single-shell emulsion to the cross-linking monomer to the cross-linking agent to the redox initiator to the water is 60-110:1-10:0.01-0.05:0.0125-0.05:1-10.

35. The preparation method according to claim 33, wherein
the polymerization monomer is acrylic acid, methacrylic acid and polyacrylamide wherein a weight ratio of acrylic acid to methacrylic acid to polyacrylamide is: 2-10:0.01-10:0.01-5;
the lubricating monomer is styrene and butyl acrylate, wherein a weight ratio of styrene to butyl acrylate is 30-45:30-40;
the cross-linking monomer is acrylic acid, styrene and butyl acrylate, wherein a weight ratio of acrylic acid to styrene to butyl acrylate is 15-20:50-70:10-15.

36. The preparation method according to claim 33, wherein step (1) further comprises adding a charring agent, a polyhydric alcohol, a heat stabilizer, a curing agent and potassium hydroxide.

37. The preparation method according to claim 36, wherein
a weight ratio of glycerol to the polymerization monomer to the charring agent to the polyhydric alcohol to the heat stabilizer to the curing agent to the potassium hydroxide to the water is 15-20:2-25:0.01-3:0.02-4:0.01-0.6:0.01-0.1:0.01-0.2:35-50;
wherein the charring agent is one or more of sucrose, fructose, glucose and granulated sugar;
the heat stabilizer is at least one of borax and boric acid;
the curing agent is one or more of sodium fluosilicate, potassium fluosilicate and aluminum fluoride; and
the polyhydric alcohol is at least one of xylitol and pentaerythritol.

38. The preparation method according to claim 33, wherein, step (4) further comprises
mixing the cross-linking monomer in advance; and
swelling after mixing the soap-free core-shell emulsion with the cross-linking monomer, water and the cross-linking agent.

39. A fireproof glue solution, comprising the fireproof glue solution matrix according to claim 25.

40. The fireproof glue solution according to claim 39, further comprising potassium hydroxide, wherein a weight ratio of the fireproof glue solution matrix to the potassium hydroxide is 70-75:2-15.

41. The fireproof glue solution according to claim 39, wherein the fireproof glue solution further comprises a charring adjuvant, an ion fixing agent, a defoaming agent and a curing agent.

42. The fireproof glue solution according to claim 41, wherein
a weight ratio of the fireproof glue solution matrix to the potassium hydroxide to the charring adjuvant to the ionic fixing agent to the defoaming agent to the curing agent is 70-75:2-15:0.01-0.2:0.01-0.1:0.01-0.05:0.01-0.2.

43. A method for preparing the fireproof glue solution according to claim 39, comprising the following steps:
(1) preparing an inner shell layer mixture solution by mixing glycerol, polymerization monomer and water, wherein the polymerization monomer is one or more of acrylic acid, methacrylic acid and polyacrylamide;
(2) preparing a soap-free seed emulsion by adding nano silicon dioxide particles and a redox initiator into the inner shell layer mixture solution under the protection of an inert gas, wherein the redox initiator is a mixture of ammonium persulfate and sodium hydrogen sulfite in a molar ratio of 1:1;
(3) preparing a soap-free single-shell emulsion by adding a lubricating monomer, water and a redox initiator into the soap-free seed emulsion, wherein the lubricating monomer is aromatic olefin and/or acrylic ester, preferably, the aromatic olefin is styrene, and the acrylic ester is butyl acrylate;
(4) preparing a fireproof glue solution matrix by adding a cross-linking monomer, water and a cross-linking agent into the soap-free single-shell emulsion and then adding a redox initiator, wherein the cross-linking monomer is acrylic acid, styrene and butyl acrylate, wherein the cross-linking agent is 1,2-divinyl benzene; and
(5) mixing the fireproof glue solution matrix with potassium hydroxide to obtain the fireproof glue solution.

44. The method according to claim 43, further comprising adding a charring adjuvant, an ion fixing agent, a defoaming agent and a curing agent;
wherein the charring adjuvant is one or more of potassium dihydrogen phosphate, potassium hydrogen phosphate, sodium dihydrogen phosphate and sodium hydrogen phosphate;
the ion fixing agent is one or more of zinc oxide, aluminum oxide and starch;
the defoaming agent is polyether modified organic silicon or polyurethane type adjuvant;
the curing agent is one or more of sodium fluosilicate, potassium fluosilicate and aluminum fluoride; and
stirring and defoaming under a vacuum degree of 10-40 mbar.
